(19) United States
(12) Patent Application Publication
(10) Pub. No.: US 2015/0188670 A1
(43) Pub. Date: Jul. 2, 2015

(54) METHOD FOR PERFORMING RETRANSMISSION TO NETWORK AT USER EQUIPMENT IN WIRELESS COMMUNICATION SYSTEM AND AN APPARATUS THEREFOR

(71) Applicant: LG ELECTRONICS INC., Seoul (KR)

(72) Inventors: Sunyoung Lee, Anyang-si (KR); Sungjun Park, Anyang-si (KR); Seungjune Yi, Anyang-si (KR)

(73) Assignee: LG ELECTRONICS INC., Seoul (KR)

(21) Appl. No.: 14/416,597

(22) PCT Filed: Sep. 3, 2013
(86) PCT No.: PCT/KR2013/007929

§ 371 Date: Jan. 22, 2015

Related U.S. Application Data
(60) Provisional application No. 61/701,732, filed on Sep. 17, 2012.

(51) Int. Cl. H04L 1/18; H04W 28/04

(52) U.S. Cl. CPC H04L 1/18; H04L 1/1819; H04W 28/04

(57) ABSTRACT

A method for processing a signal at a user equipment in a wireless communication system is disclosed. The method includes steps of receiving information on at least one PDCCH (Physical Downlink Control Channel) monitoring opportunity from a network; performing an uplink transmission to the network; receiving a response corresponding to the uplink transmission from the network; and monitoring a PDCCH including information for retransmission of the uplink transmission, in one or more PDCCH monitoring opportunities except for the at least one PDCCH monitoring opportunity.

### TECHNICAL FIELD

The present invention relates to a wireless communication system and, more particularly, to a method for performing retransmission to a network at a user equipment in a wireless communication system and an apparatus therefor.

### BACKGROUND ART

As an example of a mobile communication system to which the present invention is applicable, a 3rd Generation Partnership Project Long Term Evolution (hereinafter, referred to as LTE) communication system is described in brief.

FIG. 1 is a view schematically illustrating a network structure of an E-UMTS as an exemplary radio communication system. An Evolved Universal Mobile Telecommunications System (E-UMTS) is an advanced version of a conventional Universal Mobile Telecommunications System (UMTS) and basic standardization thereof is currently underway in the 3GPP. E-UMTS may be generally referred to as a Long Term Evolution (LTE) system. For details of the technical specifications of the UMTS and E-UMTS, reference can be made to Release 7 and Release 8 of “3rd Generation Partnership Project; Technical Specification Group Radio Access Network”.

Referring to FIG. 1, the E-UMTS includes a User Equipment (UE), eNode Bs (eNBs), and an Access Gateway (AG) which is located at an end of the network (E-UTRAN) and connected to an external network. The eNBs may simultaneously transmit multiple data streams for a broadcast service, a multicast service, and/or a unicast service.

One or more cells are present per eNB. A cell is configured to use one of bandwidths of 1.44, 3, 5, 10, 15, and 20 MHz to provide a downlink or uplink transport service to several UEs. Different cells may be set to provide different bandwidths. The eNB controls data transmission and reception for a plurality of UEs. The eNB transmits downlink scheduling information with respect to downlink data to notify a corresponding UE of a time/frequency domain in which data is to be transmitted, coding, data size, and Hybrid Automatic Repeat and reQuest (HARQ)-related information. In addition, the eNB transmits uplink scheduling information with respect to uplink data to a corresponding UE to inform the UE of an available time/frequency domain, coding, data size, and HARQ-related information. An interface may be used to transmit user traffic or control traffic between eNBs. A Core Network (CN) may include the AG, a network node for user registration of the UE, and the like. The AG manages mobility of a UE on a Tracking Area (TA) basis, each TA including a plurality of cells.

Although radio communication technology has been developed up to LTE based on Wideband Code Division Multiple Access (WCDMA), demands and expectations of users and providers continue to increase. In addition, since other radio access technologies continue to be developed, new advances in technology are required to secure future competitiveness. For example, decrease of cost per bit, increase of service availability, flexible use of a frequency band, simple structure, open interface, and suitable power consumption by a UE are required.

### DISCLOSURE

### Technical Problem

Based on the above discussion, the present invention proposes a method for performing retransmission to a network at a user equipment in a wireless communication system and an apparatus therefor.

### Technical Solution

In accordance with an embodiment of the present invention, a method for processing a signal at a user equipment in a wireless communication system includes receiving information on at least one PDCCH (Physical Downlink Control Channel) monitoring opportunity from a network; performing an uplink transmission to the network; receiving a response corresponding to the uplink transmission from the network; and monitoring a PDCCH including information for retransmission of the uplink transmission, in one or more PDCCH monitoring opportunities except for the at least one PDCCH monitoring opportunity.

Preferably, the information on at least one PDCCH monitoring opportunity includes a number of PDCCH monitoring opportunity or a pre-defined pattern of the PDCCH monitoring opportunity.

Preferably, the response corresponding to the uplink transmission is a HARQ (Hybrid Automatic Repeat and reQuest) ACK (ACKnowledgement) response corresponding to the uplink transmission.

More preferably, the method further comprises detecting the PDCCH in the one or more PDCCH monitoring opportunities except for the at least one PDCCH monitoring opportunity; and performing the retransmission of the uplink transmission based on information included in the PDCCH.

Additional, the method may further comprise receiving information on the one or more PDCCH monitoring opportunities from the network. Or, the method may further comprise receiving a DRX (Discontinuous Reception) configuration including information on the one or more PDCCH monitoring opportunities from the network

Especially, the one or more PDCCH monitoring opportunities represent a HARQ (Hybrid Automatic Repeat and reQuest) retransmission pending period. And, the PDCCH monitoring opportunity can be defined by unit of subframe.

Further, the step of performing the uplink transmission can comprise receiving a PDCCH including information for the uplink transmission. Here, a NDI (New Data Indicator) field included in the information for the uplink transmission has a same value with the NDI field included in the information for the retransmission of the uplink transmission.

It is to be understood that both the foregoing general description and the following detailed description of the present invention are exemplary and explanatory and are intended to provide further explanation of the invention as claimed.

### Advantageous Effects

According to embodiments of the present invention, the network and the user equipment can efficiently transmit and receive signals for the retransmission in a wireless communication system.

It will be appreciated by persons skilled in the art that that the effects that can be achieved through the present invention are not limited to what has been particularly described hereinabove and other advantages of the present invention will be more clearly understood from the following detailed description.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention.

In the drawings:

FIG. 1 is a diagram showing a network structure of an Evolved Universal Mobile Telecommunications System (E-UMTS) as an example of a wireless communication system.

FIG. 2 is a diagram conceptually showing a network structure of an evolved universal terrestrial radio access network (E-UTRAN).

FIG. 3 is a diagram showing a control plane and a user plane of a radio interface protocol between a UE and an E-UTRAN based on a 3rd generation partnership project (3GPP) radio access network standard.

FIG. 4 is a diagram showing physical channels used in a 3GPP system and a general signal transmission method using the same.

FIG. 5 is a diagram showing the structure of a radio frame used in a Long Term Evolution (LTE) system.

FIG. 6 is a diagram showing a general transmission and reception method using a paging message.

FIG. 7 is a diagram showing a concept DRX (Discontinuous Reception).

FIG. 8 is a diagram showing a method for a DRX operation in the LTE system.

FIG. 9 illustrates an uplink Hybrid Automatic Repeat reQuest (HARQ) operation in the LTE system.

FIG. 10 is diagram comparing a conventional operation with an operation for monitoring a Physical Downlink Control Channel (PDCCH) at a DRX-state UE according to an embodiment of the present invention.

FIG. 11 is diagram comparing a conventional operation with an operation for performing uplink retransmission at a DRX-state UE according to an embodiment of the present invention.

FIG. 12 is a block diagram of a communication apparatus according to an embodiment of the present invention.

### BEST MODE

Hereinafter, structures, operations, and other features of the present invention will be readily understood from the embodiments of the present invention, examples of which are illustrated in the accompanying drawings. Embodiments described later are examples in which technical features of the present invention are applied to a 3GPP system.

Although the embodiments of the present invention are described using a long term evolution (LTE) system and a LTE-advanced (LTE-A) system in the present specification, they are purely exemplary. Therefore, the embodiments of the present invention are applicable to any other communication system corresponding to the above definition. In addition, although the embodiments of the present invention are described based on a frequency division duplex (FDD) scheme in the present specification, the embodiments of the present invention may be easily modified and applied to a half-duplex FDD (H-FDD) scheme or a time division duplex (TDD) scheme.

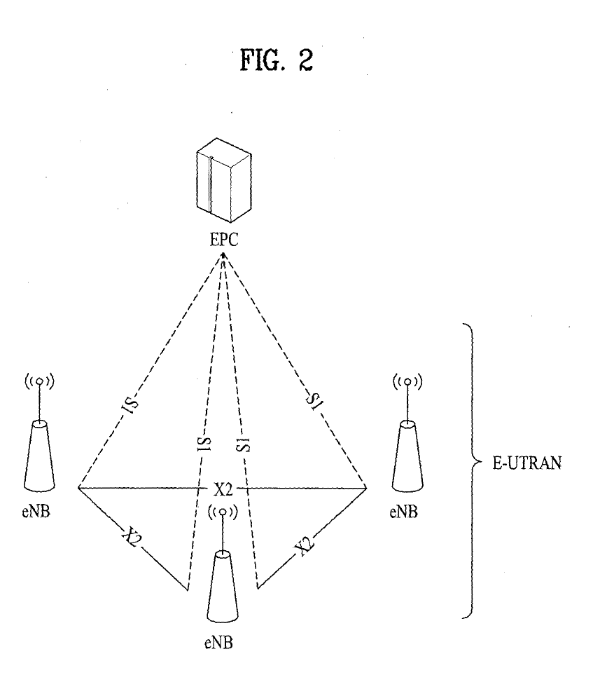

FIG. 2 is a diagram conceptually showing a network structure of an evolved universal terrestrial radio access network (E-UTRAN). An E-UTRAN system is an evolved form of a legacy UTRAN system. The E-UTRAN includes cells (eNB) which are connected to each other via an X2 interface. A cell is connected to a user equipment (UE) via a radio interface and to an evolved packet core (EPC) via an Si interface.

The EPC includes a mobility management entity (MME), a serving-gateway (S-GW), and a packet data network-gateway (PDN-GW). The MME has information about connections and capabilities of UEs, mainly for use in managing the mobility of the UEs. The S-GW is a gateway having the E-UTRAN as an end point, and the PDN-GW is a gateway having a packet data network (PDN) as an end point.

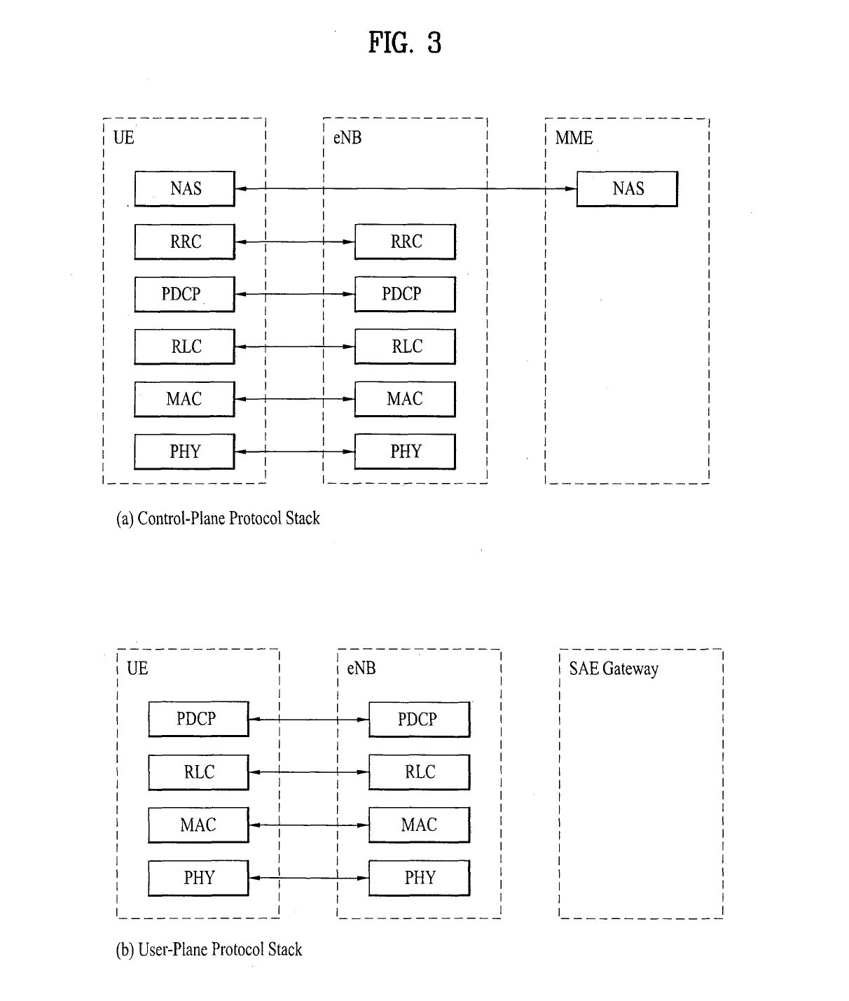

FIG. 3 is a diagram showing a control plane and a user plane of a radio interface protocol between a UE and an E-UTRAN based on a 3GPP radio access network standard. The control plane refers to a path used for transmitting control messages used for managing a call between the UE and the E-UTRAN. The user plane refers to a path used for transmitting data generated in an application layer, e.g., voice data or Internet packet data.

A physical (PHY) layer of a first layer provides an information transfer service to a higher layer using a physical channel. The PHY layer is connected to a medium access control (MAC) layer located on the higher layer via a transport channel. Data is transported between the MAC layer and the PHY layer via the transport channel. Data is transported between a physical layer of a transmitting side and a physical layer of a receiving side via physical channels. The physical channels use time and frequency as radio resources. In detail, the physical channel is modulated using an orthogonal frequency division multiple access (OFDMA) scheme in downlink and is modulated using a single carrier frequency division multiple access (SC-FDMA) scheme in uplink.

The MAC layer of a second layer provides a service to a radio link control (RLC) layer of a higher layer via a logical channel. The RLC layer of the second layer supports reliable data transmission. A function of the RLC layer may be implemented by a functional block of the MAC layer. A packet data convergence protocol (PDCP) layer of the second layer performs a header compression function to reduce unnecessary control information for efficient transmission of an Internet protocol (IP) packet such as an IP version 4 (IPv4) packet or an IP version 6 (IPv6) packet in a radio interface having a relatively small bandwidth.

A radio resource control (RRC) layer located at the bottom of a third layer is defined only in the control plane. The RRC layer controls logical channels, transport channels, and physical channels in relation to configuration, re-configuration, and release of radio bearers (RBs). An RB refers to a service that the second layer provides for data transmission between the UE and the E-UTRAN. To this end, the RRC layer of the UE and the RRC layer of the E-UTRAN exchange RRC messages with each other.

One cell of the eNB is set to operate in one of bandwidths such as 1.25, 2.5, 5, 10, 15, and 20 MHz and provides a downlink or uplink transmission service to a plurality of UEs in the bandwidth. Different cells may be set to provide different bandwidths.

Downlink transport channels for transmission of data from the E-UTRAN to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through the downlink SCH and may also be transmitted through a separate downlink multicast channel (MCH).

Uplink transport channels for transmission of data from the UE to the E-UTRAN include a random access channel (RACH) for transmission of initial control messages and an uplink SCH for transmission of user traffic or control messages. Logical channels that are defined above the transport channels and mapped to the transport channels include a broadcast control channel (BCCH), a paging control channel (PCCH), a common control channel (CCCH), a multicast control channel (MCCH), and a multicast traffic channel (MTCH).

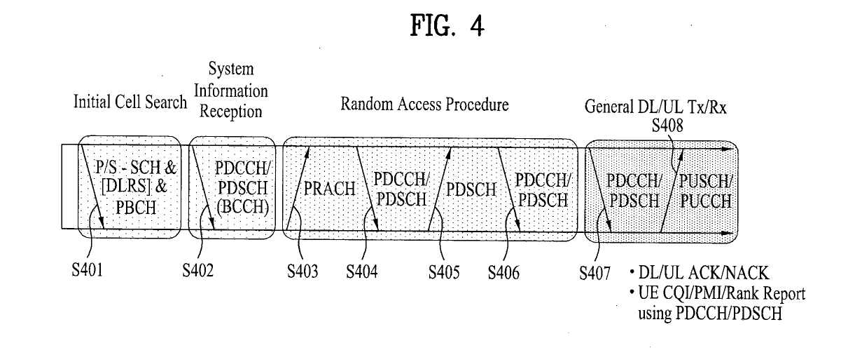

FIG. 4 is a diagram showing physical channels used in a 3GPP system and a general signal transmission method using the same.

When a UE is powered on or enters a new cell, the UE performs an initial cell search operation such as synchronization with an eNB (S401). To this end, the UE may receive a primary synchronization channel (P-SCH) and a secondary synchronization channel (S-SCH) from the eNB to perform synchronization with the eNB and acquire information such as a cell ID. Then, the UE may receive a physical broadcast channel from the eNB to acquire broadcast information in the cell. During the initial cell search operation, the UE may receive a downlink reference signal (DL RS) so as to confirm a downlink channel state.

After the initial cell search operation, the UE may receive a physical downlink control channel (PDCCH) and a, physical downlink control channel (PDSCH) based on information included in the PDCCH to acquire more detailed system information (S402).

When the UE initially accesses the eNB or has no radio resources for signal transmission, the UE may perform a random access procedure (RACH) with respect to the eNB (steps S403 to S406). To this end, the UE may transmit a specific sequence as a preamble through a physical random access channel (PRACH) (S403) and receive a response message to the preamble through the PDCCH and the PDSCH corresponding thereto (S404). In the case of contention-based RACH, the UE may further perform a contention resolution procedure.

After the above procedure, the UE may receive PDCCH/PDSCH from the eNB (S407) and may transmit a physical uplink shared channel (PUSCH)/physical uplink control channel (PUCCH) to the eNB (S408), which is a general uplink/downlink signal transmission procedure. Particularly, the UE receives downlink control information (DCI) through the PDCCH. Here, the DCI includes control information such as resource allocation information for the UE. Different DCI formats are defined according to different usages of DCI.

Control information transmitted from the UE to the eNB in uplink or transmitted from the eNB to the UE in downlink includes a downlink/uplink acknowledge/negative acknowledge (ACK/NACK) signal, a channel quality indicator (CQI), a precoding matrix index (PMI), a rank indicator (RI), and the like. In the case of the 3GPP LTE system, the UE may transmit the control information such as CQI/PMI/RI through the PUSCH and/or the PUCCH.

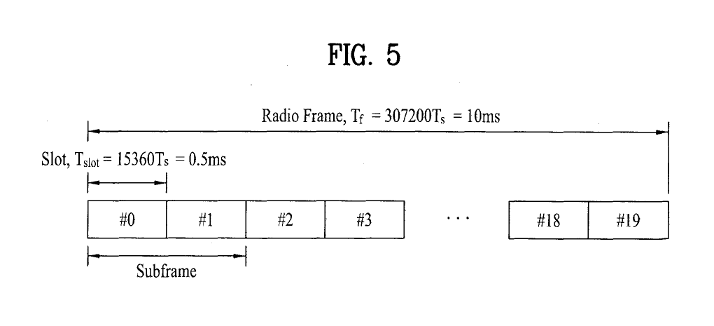

FIG. 5 is a diagram showing the structure of a radio frame used in an LTE system.

Referring to FIG. 5, the radio frame has a length of 10 ms (327200×Ts) and is divided into 10 subframes having the same size. Each of the subframes has a length of 1 ms and includes two slots. Each of the slots has a length of 0.5 ms (15360XTs). Ts denotes a sampling time, and is represented by Ts=1/(15 kHz×2048)=3.2552×10-8 (about 33 ns). Each of the slots includes a plurality of OFDM symbols in a time domain and a plurality of Resource Blocks (RBs) in a frequency domain. In the LTE system, one RB includes 12 subcarriers×7 (or 6) OFDM symbols. A transmission time interval (TTI) that is a unit time for transmission of data may be determined in units of one or more subframes. The structure of the radio frame is purely exemplary and thus the number of subframes included in the radio frame, the number of slots included in a subframe, or the number of OFDM symbols included in a slot may be changed in various ways.

Hereinafter, an RRC state of a UE and an RRC connection method will be described.

The RRC state indicates whether the RRC layer of the UE is logically connected to the RRC layer of the E-UTRAN. When the RRC connection is established, the UE is in a RRC_CONNECTED state. Otherwise, the UE is in a RRC_IDLE state.

The E-UTRAN can effectively control UEs because it can check the presence of RRC_CONNECTED UEs on a cell basis. On the other hand, the E-UTRAN cannot check the presence of RRC_IDLE UEs on a cell basis and thus a CN manages RRC_IDLE UEs on a TA basis. A TA is an area unit larger than a cell. That is, in order to receive a service such as a voice service or a data service from a cell, the UE needs to transition to the RRC_CONNECTED state.

In particular, when a user initially turns a UE on, the UE first searches for an appropriate cell and camps on the cell in the RRC_IDLE state. The RRC_IDLE UE transitions to the RRC_CONNECTED state by performing an RRC connection establishment procedure only when the RRC_IDLE UE needs to establish an RRC connection. For example, when uplink data transmission is necessary due to call connection attempt of a user or when a response message is transmitted in response to a paging message received from the E-UTRAN, the RRC_IDLE UE needs to be RRC connected to the E-UTRAN.

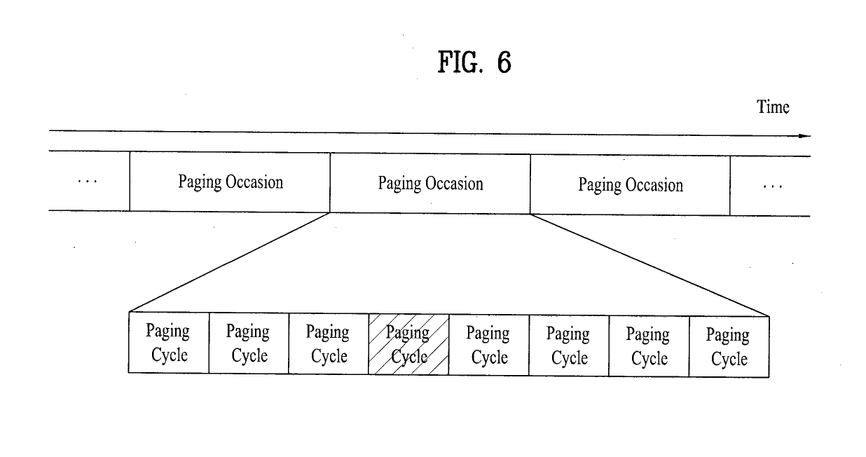

FIG. 6 is a diagram showing a general transmission and reception method using a paging message.

Referring to FIG. 6, the paging message includes a paging record having paging cause and UE identity. Upon receiving the paging message, the UE may perform a discontinuous reception (DRX) operation in order to reduce power consumption.

In detail, a network configures a plurality of paging occasions (POs) in every time cycle called a paging DRC cycle and a specific UE receives only a specific paging occasion and acquires a paging message. The UE does not receive a paging channel in paging occasions other than the specific paging occasion and may be in a sleep state in order to reduce power consumption. One paging occasion corresponds to one TTI.

The eNB and the UE use a paging indicator (PI) as a specific value indicating transmission of a paging message. The eNB may define a specific identity (e.g., paging—radio network temporary identity (P-RNTI)) as the PI and inform the UE of paging information transmission. For example, the UE wakes up in every DRX cycle and receives a subframe to determine the presence of a paging message directed thereto. In the presence of the P-RNTI on an L1/L2 control channel (a PDCCH) in the received subframe, the UE is aware that a paging message exists on a PDSCH of the subframe. When the paging message includes an ID of the UE (e.g., an international mobile subscriber identity (IMSI)), the UE receives a service by responding to the eNB (e.g., establishing an RRC connection or receiving system information).

Hereinafter, a DRX (Discontinuous Reception) will be described. The DRX is a method for saving of a power consumption by allowing to monitor a PDCCH discontinuously.

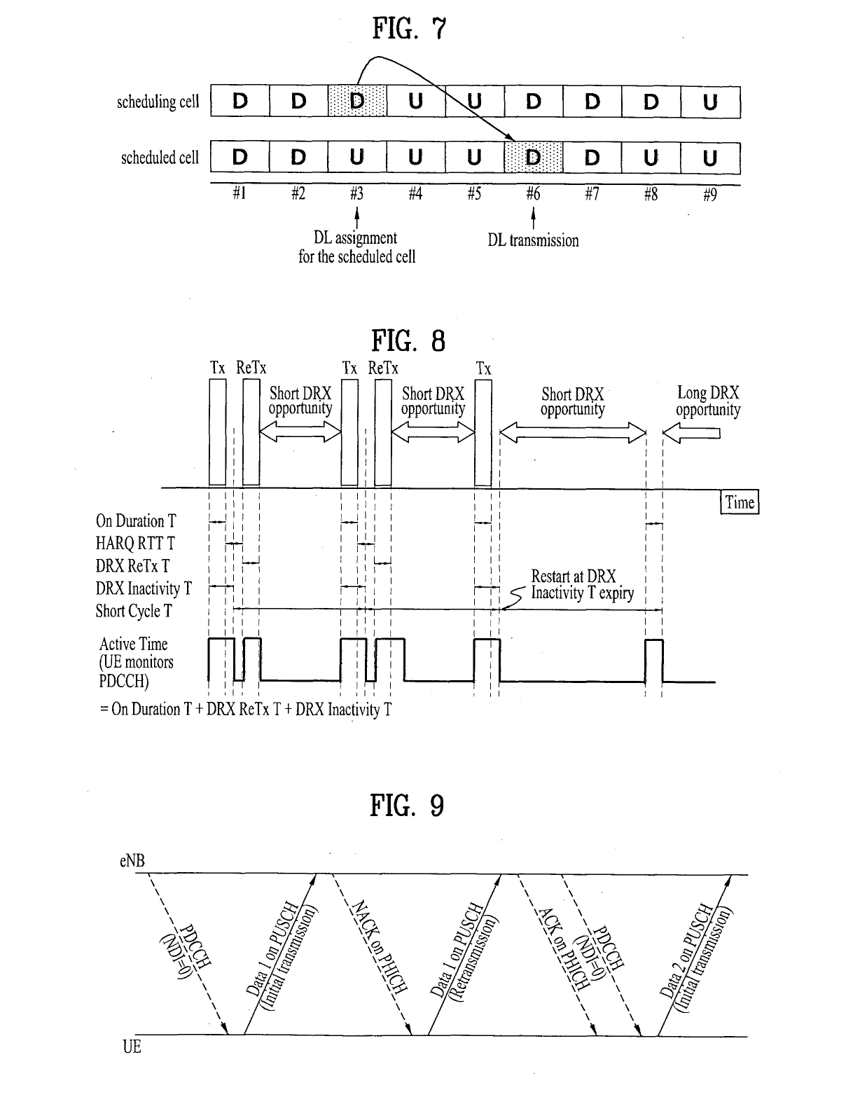

FIG. 7 is a diagram showing a concept DRX (Discontinuous Reception).

Referring to FIG. 7, if DRX is set for a UE in RRC_CONNECTED state, the UE attempts to receive a downlink channel, PDCCH, that is, performs PDCCH monitoring only during a predetermined time period, while the UE does not perform PDCCH monitoring during the remaining time period. A time period during which the UE should monitor a PDCCH is referred to as On Duration. On Duration is defined per DRX cycle. That is, a DRX cycle is a repetition period of On Duration.

The UE always monitors a PDCCH during On Duration in one DRX cycle and a DRX cycle determines a period in which On Duration is set. DRX cycles are classified into a long DRX cycle and a short DRX cycle according to the periods of the DRX cycles. The long DRX cycle may minimize the battery consumption of a UE, whereas the short DRX cycle may minimize a data transmission delay.

When the UE receives a PDCCH during On Duration in a DRX cycle, an additional transmission or a retransmission may take place during a time period other than the On Duration. Therefore, the UE should monitor a PDCCH during a time period other than the On Duration. That is, the UE should perform PDCCH monitoring during a time period over which an inactivity managing timer, drx-InactivityTimer or a retransmission managing timer, drx-RetransmissionTimer as well as an On Duration managing timer, onDurationTimer is running. The value of each of the timers is defined as the number of subframes. The number of subframes is counted until the value of a timer is reached. If the value of the timer is satisfied, the timer expires.

Additionally, the UE should perform PDCCH monitoring during random access or when the UE transits a scheduling request and attempts to receive a UL grant.

A time period during which a UE should perform PDCCH monitoring is referred to as an Active Time. The Active Time includes On Duration during which a PDCCH is monitored periodically and a time interval during which a PDCCH is monitored upon generation of an event.

More specifically, the Active Time includes the time while (1) onDurationTimer or drx-InactivityTimer or drx-RetransmissionTimer or mac-ContentionResolutionTimer is running, or (2) a Scheduling Request is sent on PUCCH and is pending, or (3) an uplink grant for a pending HARQ retransmission can occur and there is data in the corresponding HARQ buffer, or (4) a PDCCH indicating a new transmission addressed to the C-RNTI of the UE has not been received after successful reception of a Random Access Response for the preamble not selected by the UE.

FIG. 8 is a diagram showing a method for a DRX operation in the LTE system. Referring to FIG. 8, the UE may be configured by RRC with a DRX functionality shall perform following operations for each TTI (that is, each subframe).

If a HARQ RTT (Round Trip Time) Timer expires in this subframe and the data of the corresponding HARQ process was not successfully decoded, the UE shall start the drx-RetransmissionTimer for the corresponding HARQ process.

Further, if a DRX Command MAC control element (CE) is received, the UE shall stop onDurationTimer and drx-InactivityTimer. The DRX Command MAC CE is a command for shifting to a DRX state, is identified by a LCID (Logical Channel ID) field of a MAC PDU (Protocol Data Unit) subheader.

Further, in case that drx-InactivityTimer expires or a DRX Command MAC CE is received in this subframe, if the Short DRX cycle is configured, the UE shall start or restart drxShortCycleTimer, and use the Short DRX Cycle. However, if the Short DRX cycle is not configured, the Long DRX cycle is used. Additionally, if drxShortCycleTimer expires in this subframe, the Long DRX Cycle is also used.

Furthermore, if the Short DRX Cycle is used and [(SFN*10)+subframe number] modulo (shortDRX-Cycle) is (drxStartOffset) modulo (shortDRX-Cycle), or if the Long DRX Cycle is used and [(SFN*10)+subframe number] modulo (longDRX-Cycle) is drxStartOffset, the UE shall start onDurationTimer.

The UE shall monitor the PDCCH for a PDCCH-subframe during the Active Time. If the PDCCH indicates a DL transmission or if a DL assignment has been configured for this subframe, the UE shall start the HARQ RTT Timer for the corresponding HARQ process and stop the drx-RetransmissionTimer for the corresponding HARQ process. If the PDCCH indicates a (DL or UL) new transmission, the UE shall start or restart drx-InactivityTimer.

Here, the PDCCH-subframe is defined as a subframe with PDCCH. That is, the PDCCH-subframe is a subframe on which the PDCCH can be transmitted. More specifically, in a FDD (frequency division duplex) system, the PDCCH-subframe represents any subframe. For full-duplex TDD (time division duplex) system, the PDCCH-subframe represents the union of downlink subframes and subframes including DwPTS of all serving cells, except serving cells that are configured with schedulingCellId (that is, the Scheduled cell). Further, for half-duplex TDD system, the PDCCH-subframe represents the subframes where the PCell (primary cell) is configured as a downlink subframe or a subframe including DwPTS.

Meanwhile, when not in Active Time, the UE does not perform a SRS (Sounding Reference Signal) transmission and a CSI reporting, which are triggered by the eNB.

During the above DRX operation, only the HARQ RTT Timer is fixed to 8 ms, whereas the eNB indicates the other timer values, onDurationTimer, drx-InactivityTimer, drx-RetransmissionTimer, and mac-ContentionResolutionTimer to the UE by an RRC signal. The eNB also indicates a long DRX cycle and a short DRX cycle, which represent the period of a DRX cycle, to the UE by an RRC signal.

Now, an uplink HARQ operation will be described. For efficient data transmission, an uplink HARQ operation is performed at the MAC layer in the LTE system.

Specifically, an eNB transmits uplink scheduling information or a UL grant to a UE on a PDCCH in order to receive data from the UE in HARQ.

The uplink scheduling information includes a UE ID such as a C-RNTI or a semi-persistent scheduling C-RNTI, a resource block assignment, a transmission parameter such as a modulation and coding scheme index and a redundancy version, and a New Data Indicator (NDI).

In the LTE system, the UE has eight HARQ processes and the HARQ processes are performed synchronously. Each HARQ process is allocated synchronously every TTI. That is, HARQ process #1 to HARQ process #8 are allocated to TTI #1 to TTI #8, respectively and then HARQ processes #1 and #2 are allocated to TTIs #9 and #10, respectively.

Since the HARQ processes are allocated synchronously, an HARQ process allocated to a TTI during which a PDCCH is received for initial transmission of specific data is used for the data transmission. For example, if a UE receives a PDCCH carrying uplink scheduling information in TTI #N, the UE transmits uplink data in TTI #(N+4). In other words, HARQ process #K allocated to TTI #(N+4) is used for the uplink data transmission.

The UE performs HARQ retransmission non-adaptively. That is, the UE can initially transmit specific data only when the UE receives a PDCCH carrying uplink scheduling information. However, the UE may perform HARQ retransmission of the data without receiving a PDCCH in a TTI to which the next corresponding HARQ process is allocated, using the same uplink scheduling information as used for the initial transmission.

A transmission parameter is transmitted on a PDCCH and may be changed according to a channel state. For example, if the channel state is better than at an initial transmission, data may be transmitted at a higher bit rate by changing a modulation order or a payload size. On the contrary, if the channel state is poorer than at the initial transmission, data may be transmitted at a lower bit rate than at the initial transmission.

The UE checks uplink scheduling information directed to the UE by monitoring a PDCCH in every TTI and then transmits data on a PUSCH based on the uplink scheduling information. The UE first generates the data in a MAC PDU, stores the MAC PDU in an HARQ buffer, and then transmits the MAC PDU according to the uplink scheduling information.

Subsequently, the UE awaits reception of an HARQ feedback for the transmitted data from the eNB. Upon receipt of an HARQ Negative Acknowledgement (NACK) for the data from the eNB, the UE retransmits the data in a retransmission RRI of an HARQ process including the data. On the other hand, upon receipt of an HARQ Acknowledgement (ACK) from the eNB, the UE discontinues HARQ retransmission of the data.

When the UE transmits data in HARQ, the UE counts the number of HARQ transmissions, CURRENT_TX_NB. If the number of HARQ transmissions, CURRENT_TX_NB is equal to a maximum transmission number set by a higher layer, the UE flushes data from the HARQ buffer.

The UE determines whether to retransmit data in HARQ according to an HARQ feedback from the eNB, the presence or absence of data in an HARQ buffer, and the transmission time of a corresponding HARQ process. That is, if the UE has already transmitted data to the eNB and received an HARQ NACK for the data from the eNB, and the number of HARQ transmissions, CURRENT_TX_NB is not equal to a maximum transmission number, the UE still preserves the data in the HARQ buffer and thus retransmits the data to the eNB. For reference, one HARQ process has one HARQ buffer.

Upon receipt of uplink scheduling information, the UE determines whether data to be transmitted is initial transmission data or retransmission data, based on an NDI field signaled on a PDCCH. The NDI field is 1-bit information that is toggled in the order of 0→1→0→1→ . . . each time new data is transmitted. The NDI field for retransmission is set to the same value for initial transmission. Thus, the UE may determine whether data is to be initially transmitted or retransmitted by comparing a current NDI field with the previous NDI field.

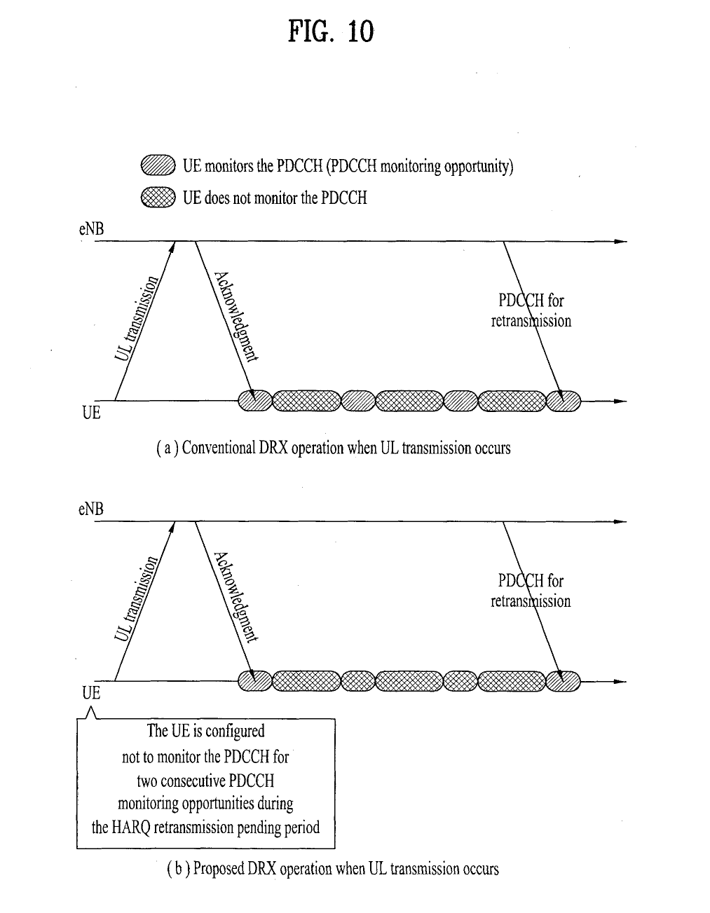

FIG. 9 illustrates an uplink HARQ operation in the LTE system.

Referring to FIG. 9, a UE receives uplink scheduling information for an initial transmission from an eNB on a PDCCH. The UE transmits Data 1 on a PUSCH to the eNB based on the uplink scheduling information.

The UE receives an HARQ feedback for Data 1, while monitoring a PDCCH in case the eNB commands adaptive retransmission. In FIG. 9, the UE receives an HARQ NACK and performs non-adaptive retransmission because it does not receive a PDCCH for adaptive retransmission. If the UE receives a PDCCH for adaptive retransmission, the UE performs adaptive retransmission.

If the UE is in DRX state, having retransmission data in an HARQ buffer, resource allocation information for the data retransmission, that is, a UL grant may be transmitted during an HARQ retransmission pending period. To be allocated resources for HARQ retransmission, the UE performs PDCCH monitoring, determining the HARQ retransmission pending period as Active Time.

If the UE receives an HARQ ACK for transmitted uplink data from the eNB, the eNB may have transmitted the HARQ ACK for the purpose of scheduling despite failed reception of the data or the eNB may have transmitted an HARQ NACK but the HARQ ACK is received at the UE due to a radio channel error. Therefore, the UE should monitor a PDCCH for adaptive retransmission for the above cases.

The eNB may not schedule the UE intentionally for a long time. Since it is difficult for the UE to predict this scheduling, the conventional operation is not favorable in terms of power consumption of the UE.

Accordingly, when the UE determines whether a specific subframe corresponds to Active Time during a DRX operation, the UE does not monitor a PDCCH during a specific time interval of an HARQ retransmission pending period, considering the specific time interval is not Active Time in the present invention.

The eNB configures the UE not to monitor the PDCCH during the HARQ retransmission pending period by means of an indication. The indication is sent by using RRC signalling, MAC signalling, or the PDCCH. If the UE receives this indication from the eNB, and if the indication indicates that the UE does not need to monitor the PDCCH for a certain period of time during the HARQ retransmission pending period, the UE does not monitor the PDCCH for the certain period of time specified by the indication during the HARQ retransmission pending period.

The period of time for which the UE does not monitor the PDCCH during the HARQ retransmission pending period is defined by a number of the subframes, or a number of the PDCCH monitoring opportunity, or a specific Time period, or a pre-defined pattern of the PDCCH monitoring opportunity.

FIG. 10 is a diagram comparing a conventional operation with a PDCCH monitoring operation of a DRX-state UE according to an embodiment of the present invention. Specifically, FIG. 10(a) illustrates the conventional PDCCH monitoring operation and FIG. 10(b) illustrates the PDCCH monitoring operation according to the embodiment of the present invention.

For the convenience of description, it is assumed that the maximum number of HARQ retransmission is 4, and the UE receives the indication which indicates that the UE does not need to monitor the PDCCH for two consecutive times of the PDCCH monitoring opportunity during the HARQ retransmission pending period.

In this case, upon receiving the feedback of acknowledgement from the eNB, the UE starts not monitoring the PDCCH and then, after two times of the PDCCH monitoring opportunity are passed, the UE restarts monitoring the PDCCH for the uplink grant of the pending HARQ retransmission.

In addition, the definition of Active Time (i.e. the time period where the UE monitors the PDCCH) is modified depending on the indication so that the Active Time does not include a certain period of time during the HARQ retransmission pending period if the indication indicates that the UE does not need to monitor the PDCCH during the certain period of time during the HARQ retransmission pending period.

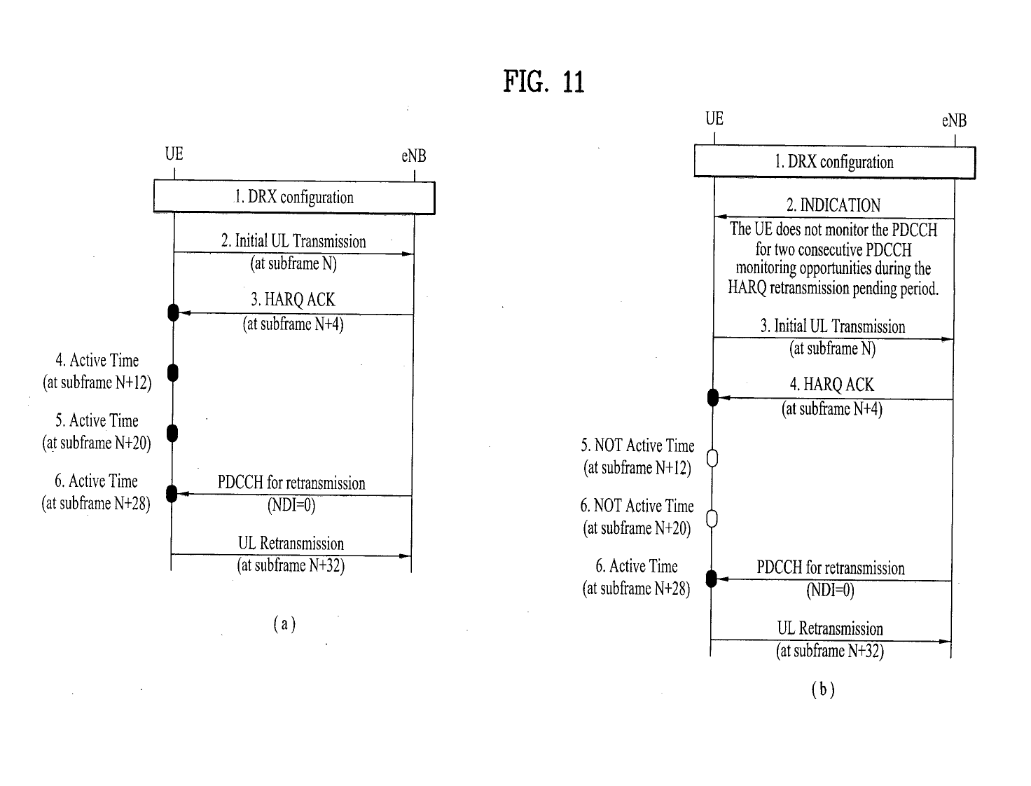

FIG. 11 is a diagram comparing a conventional method with an uplink retransmission method of a DRX-state UE according to an embodiment of the present invention. Specifically, FIG. 11(a) illustrates the conventional uplink retransmission method and FIG. 11(b) illustrates the uplink retransmission method according to the embodiment of the present invention.

Referring to FIG. 11(b), a UE receives from an eNB DRX information and an indicator allowing the UE not to perform two consecutive PDCCH monitorings during an HARQ retransmission pending period in steps 1 and 2. In the presence of retransmission data in an HARQ buffer, the UE is configured, by the indicator, not to perform PDCCH monitoring in two PDCCH monitoring opportunities during a time period in which resource allocation information (i.e. a UL grant) may be transmitted for the data retransmission, that is, during an HARQ retransmission pending period.

Subsequently, the UE transmits data to the eNB in subframe #N in step 3. The data transmission is an initial HARQ transmission. In step 4, the UE receives an HARQ ACK in subframe #(N+4) from the eNB.

In this case, the UE determines whether to determine subframe #(N+12) in which uplink resource allocation information for adaptive retransmission of the data may be received, as Active Time in step 5. Since the UE is configured not to perform PDCCH monitoring in two PDCCH monitoring opportunities during the HARQ retransmission pending period, the UE does not determine subframe #(N+12) as Active Time.

The UE also determines whether to determine subframe #(N+20) in which uplink resource allocation information for adaptive retransmission of the data may be received, as Active Time in step 6. Likewise, since the UE is configured not to perform PDCCH monitoring in two PDCCH monitoring opportunities during the HARQ retransmission pending period, the UE does not determine subframe #(N+20) as Active Time.

Because the UE has not performed PDCCH monitoring in the two consecutive PDCCH monitoring opportunities, considering subframes #(N+12) and #(N+20) as non-Active Time, the UE performs PDCCH monitoring in subframe #(N+28), considering subframe #(N+28) as Active Time in step 7.

Since the UE receives uplink resource allocation information for retransmission from the eNB in subframe #(N+28), the UE performs HARQ retransmission in subframe #(N+28).

According to the present invention, the power consumption of a UE can be reduced by preventing the UE from performing unnecessary PDCCH monitoring in a situation where the UE cannot predict scheduling of an eNB.

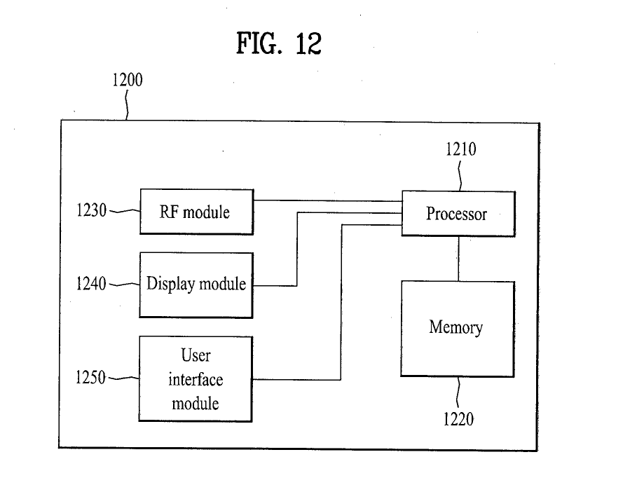

FIG. 12 is a block diagram illustrating a communication apparatus in accordance with an embodiment of the present invention.

Referring to FIG. 12, a communication device 1200 includes a processor 1210, a memory 1220, an Radio Frequency (RF) module 1230, a display module 1240, and a user interface module 1250.

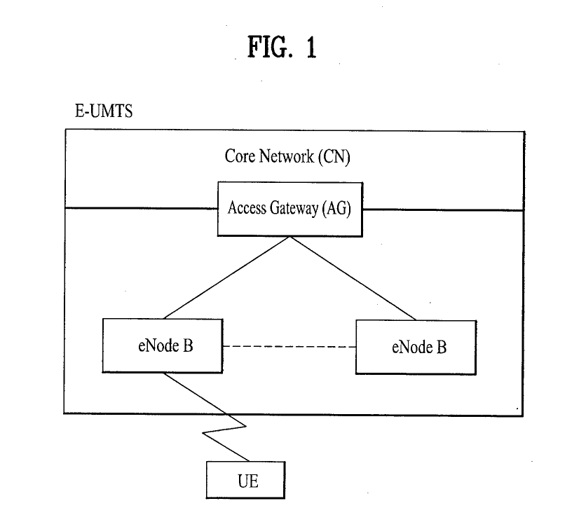

The communication device 1200 is illustrated for convenience of the description and some modules may be omitted. Moreover, the communication device 1200 may further include necessary modules. Some modules of the communication device 1200 may be further divided into sub-modules. The processor 1200 is configured to perform operations according to the embodiments of the present invention exemplarily described with reference to the figures. Specifically, for the detailed operations of the processor 1200, reference may be made to the contents described with reference to FIGS. 1 to 11.

The memory 1220 is connected to the processor 1210 and stores operating systems, applications, program code, data, and the like. The RF module 1230 is connected to the processor 1210 and performs a function of converting a baseband signal into a radio signal or converting a radio signal into a baseband signal. For this, the RF module 1230 performs analog conversion, amplification, filtering, and frequency upconversion or inverse processes thereof The display module 1240 is connected to the processor 1210 and displays various types of information. The display module 1240 may include, but is not limited to, a well-known element such as a Liquid Crystal Display (LCD), a Light Emitting Diode (LED), or an Organic Light Emitting Diode (OLED). The user interface module 1250 is connected to the processor 1210 and may include a combination of well-known user interfaces such as a keypad and a touchscreen.

The above-described embodiments are combinations of elements and features of the present invention in a predetermined manner. Each of the elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. In the appended claims, it will be apparent that claims that are not explicitly dependent on each other can be combined to provide an embodiment or new claims can be added through amendment after the application is filed.

The embodiments according to the present invention can be implemented by various means, for example, hardware, firmware, software, or combinations thereof In the case of a hardware configuration, the embodiments of the present invention may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In the case of a firmware or software configuration, the method according to the embodiments of the present invention may be implemented by a type of a module, a procedure, or a function, which performs functions or operations described above. For example, software code may be stored in a memory unit and then may be executed by a processor. The memory unit may be located inside or outside the processor to transmit and receive data to and from the processor through various well-known means.

The present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents and all changes coming within the meaning and equivalency range of the appended claims are intended to be embraced therein.

### INDUSTRIAL APPLICABILITY

While the above-described method for performing retransmission to a network at a user equipment in a wireless communication system has been described centering on an example applied to the 3GPP LTE system, the present invention is applicable to a variety of wireless communication systems in addition to the 3GPP LTE system.

1. A method for processing a signal at a user equipment in a wireless communication system, the method comprising:
receiving information on at least one PDCCH (Physical Downlink Control Channel) monitoring opportunity from a network;
performing an uplink transmission to the network;
receiving a response corresponding to the uplink transmission from the network; and
monitoring a PDCCH including information for retransmission of the uplink transmission, in one or more PDCCH monitoring opportunities except for the at least one PDCCH monitoring opportunity.

2. The method of claim 1, wherein the information on at least one PDCCH monitoring opportunity includes a number of PDCCH monitoring opportunity or a pre-defined pattern of the PDCCH monitoring opportunity.

3. The method of claim 1, wherein the response corresponding to the uplink transmission is a HARQ (Hybrid Automatic Repeat and reQuest) ACK (ACKnowledgement) response corresponding to the uplink transmission.

4. The method of claim 1, further comprising:
detecting the PDCCH in the one or more PDCCH monitoring opportunities except for the at least one PDCCH monitoring opportunity; and
performing the retransmission of the uplink transmission based on information included in the PDCCH.

5. The method of claim 1, further comprising:
receiving information on the one or more PDCCH monitoring opportunities from the network.

6. The method of claim 1, wherein the one or more PDCCH monitoring opportunities represent a HARQ (Hybrid Automatic Repeat and reQuest) retransmission pending period.

7. The method of claim 1, wherein the PDCCH monitoring opportunity is defined by unit of subframe.

8. The method of claim 1, wherein performing the uplink transmission comprises receiving a PDCCH including information for the uplink transmission.

9. The method of claim 8, wherein a NDI (New Data Indicator) field included in the information for the uplink transmission has a same value with the NDI field included in the information for the retransmission of the uplink transmission.

10. The method of claim 1, further comprising:
receiving a DRX (Discontinuous Reception) configuration including information on the one or more PDCCH monitoring opportunities from the network.
